(19) United States
(12) Patent Application Publication
(10) Pub. No.: US 2012/0013045 A1
(43) Pub. Date: Jan. 19, 2012

(54) MATTE LAMINATE FILM

(76) Inventors: Norio SUGIMURA, Niihama-shi (JP); Koji Koyama, Niihama-shi (JP); Shinsuke Ochiai, Niihama-shi (JP)

(21) Appl. No.: 13/240,974

(22) Filed: Sep. 22, 2011

Related U.S. Application Data
(62) Division of application No. 12/416,719, filed on Apr. 1, 2009.

(30) Foreign Application Priority Data
Apr. 2, 2008 (JP) 2008-095863

(51) Int. Cl. B29C 59/16; B29C 59/00

(52) U.S. Cl. 264/447; 264/129

(57) ABSTRACT

A matte laminate film comprising a transparent resin film substrate and a matte layer formed on at least one surface of the transparent resin film substrate, in which the transparent resin film substrate is a laminate film comprising a layer (A) formed of a polycarbonate resin and a layer (B) formed of a methacrylic resin which is laminated on at least one surface of the layer (A). The matte laminate film is preferably used as a decorative film having good resistance to whitening and high mechanical properties and surface hardness.

This application is a divisional of U.S. patent application Ser. No. 12/416,719, filed on Apr. 1, 2009, which claims priority to Patent Application No. JP-2008-095863, filed in Japan on April 2, 2008, the entire contents of which is incorporated herein by reference.

### FIELD OF THE INVENTION

The present invention relates to a matte laminate film. The present invention also relates to a decorative film or a decorative sheet and a decorative molded article using the matte laminate film.

### BACKGROUND ART

Methacrylic resin films are preferably used as surface-decorative films for the exterior members of household electric appliances and the interior members of automobiles by making the best use of their excellent transparency and weathering resistance (see JP-A-8-323934, JP-A-10-279766, JP-A-11-147237 and JP-A-2002-80678). Hitherto, a plastic plate such as an acrylic resin plate or a polycarbonate resin plate is generally used as a substrate which is matted or grained. For example, the surface of a substrate is matted or grained by thermoforming, and the substrate is used as a decorative molded article. In these years, as a method for producing such a highly decorative molded article, a film-lamination method such as a simultaneous injection molding-lamination method has been frequently employed, and a matte acrylic resin film has been increasingly desired. As the matte methacrylic resin film, a film produced by film formation after mixing a methacrylic resin with a matting agent (see JP-A-2000-72894 and JP-A-2002-361712), a film produced by transferring minute unevennesses of a roll to the surface of the film in a film formation process (see JP-A-2002-361712), and a film produced by forming a matte layer on a methacrylic resin film by a coating method (see JP-A-2003-211598 and JP-A-2006-142815) have been used.

The matte methacrylic resin film often contains acrylic rubber particles to impart mechanical strengths necessary for the film. However, such a methacrylic resin film has a drawback such that it is easily whitened when it is bent or when it is integrated with a thermoplastic resin by the simultaneous injection molding-lamination method. To overcome such a drawback, the use of rubber particles having a relatively small particle size is proposed. In this case, a larger amount of the rubber particles should be added to the methacrylic resin to impart necessary mechanical strength to the methacrylic resin film. However, the use of a larger amount of the rubber particles decreases the surface hardness of the film.

### SUMMARY OF THE INVENTION

An object of the present invention is to provide a matte resin film having good resistance to whitening and high surface hardness, suitable for use in a simultaneous injection molding-lamination method. Another object of the present invention is to provide a decorative film or sheet and also a decorative molded article, each of which comprises such a matte resin film and thus has good resistance to whitening and high surface hardness.

As a result of extensive studies by the present inventors, it has found that the above object can be attained by using, as a transparent resin film substrate, a laminate film comprising a methacrylic resin layer laminated on at least one surface of a polycarbonate resin layer and forming a matte layer on at least one surface of the laminate film substrate, and thus the present invention has been completed.

Accordingly, the present invention provides a matte laminate film comprising a transparent resin film substrate and a matte layer formed on at least one surface of the transparent resin film substrate, wherein said transparent resin film substrate is a laminate film comprising a layer (A) formed of a polycarbonate resin and a layer (B) formed of a methacrylic resin which is laminated on at least one surface of the layer (A).

The matte laminate film of the present invention can be used as a decorative film, for example, by forming a decoration on the surface of the matte laminate film opposite to the matte layer, when the matte laminate film comprises a transparent resin film substrate and a matte layer formed on one surface thereof. Also, a decorative sheet can be produced by laminating a thermoplastic resin sheet on the surface having a decoration. In addition, a decorative molded article can be produced by laminating a thermoplastic resin molded article on the surface of the decorative film having a decoration or on the surface of the decorative sheet on which the thermoplastic resin sheet is laminated.

Since the matte laminate film of the present invention has excellent resistance to whitening, and also high mechanical strength and surface hardness, a decorative film or sheet and a decorative molded article having good designability and high surface hardness can be obtained by using the matte laminate film.

### DETAILED DESCRIPTION OF THE INVENTION

Hereinafter, the present invention will be described in detail. The matte laminate film of the present invention is a matte film comprising a transparent resin film substrate and a matte layer formed on at least one surface thereof. The transparent resin film substrate is a laminate film comprising a layer (A) which comprises a polycarbonate resin and a layer (B) which comprises a methacrylic resin and acrylic rubber particles formed on at least one surface of the layer (A).

Examples of the polycarbonate resin forming the layer (A) include polycarbonate prepared by reacting a dihydric phenol with a carbonylating agent by an interfacial polycondensation method or a melt transesterification method; polycarbonate prepared by polymerizing a carbonate prepolymer by a solid phase transesterification method; and polycarbonate prepared by polymerizing a cyclic carbonate compound by a ring-opening polymerization method.

Specific examples of the dihydric phenol include hydroquinone, resorcinol, 4,4′-dihydroxydiphenyl, bis(4-hydroxyphenyl)methane, bis{(4-hydroxy-3,5-dimethyl)phenyl}-methane, 1,1-bis(4-hydroxyphenyl)-ethane, 1,1-bis(4-hydroxyphenyl)-1-phenylethane, 2,2-bis(4-hydroxyphenyl)-propane (bisphenol A), 2,2-bis{(4-hydroxy-3-methyl)phenyl}-propane, 2,2-bis{(4-hydroxy-3,5-dimethyl)phenyl}propane, 2,2-bis{(4-hydroxy-3,5-dibromo)phenyl}propane, 2,2-bis{(3-isopropyl-4-hydroxy)phenyl}propane, 2,2-bis{(4-hydroxy-3-phenyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,4-bis(4-hydroxyphenyl)-2-methylbutane, 2,2-bis(4-hydroxyphenyl)-pentane, 2,2-bis(4-hydroxyphenyl)-4-methylpentane, 1,1-bis(4-hydroxyphenyl)cyclohexane, 1,1-bis(4-hydroxyphenyl)-4-isopropylcyclohexane, 1,1-bis(4-hydroxyphenyl)-3,3,5-trimethylcyclohexane, 9,9-bis(4-hydroxyphenyl)fluorene, 9,9-bis{(4-hydroxy-3-methyl)phenyl}fluorene, α,α′-bis(4-hydroxyphenyl)-o-diisopropylbenzene, α,α′-bis(4-hydroxyphenyl)-m-diisopropylbenzene, α,α′-bis(4-hydroxyphenyl)-p-diisopropylbenzene, 1,3-bis(4-hydroxyphenyl)-5,7-dimethyladamantane, 4,4′-dihydroxy-diphenylsulfone, 4,4′-dihydroxydiphenylsulfoxide, 4,4′-dihydroxydiphenylsulfide, 4,4′-dihydroxydiphenylketone, 4,4′-dihydroxydiphenylether, 4,4′-dihydroxydiphenylester, etc. They may be used independently or as a mixture of two or more of them.

Among them, bisphenol A, 2,2-bis{(4-hydroxy-3-methyl)phenyl}-propane, 2,2-bis(4-hydroxyphenyl)butane, 2,2-bis(4-hydroxyphenyl)-3-methyl-butane, 2,2-bis(4-hydroxyphenyl)-3,3-dimethylbutane, 2,2-bis(4-hydroxyphenyl)-4-methylpentane, 1,1-bis(4-hydroxyphenyl)-3,3,5-trimethylcyclohexane and α,α′-bis(4-hydroxyphenyl)-m-diisopropylbenzene or a mixture of two or more of them are preferably used. In particular, bisphenol A alone, or a mixture of 1,1-bis(4-hydroxyphenyl)-3,3,5-trimethylcyclohexane with at least one dihydric phenol selected from the group consisting of bisphenol A, 2,2-bis{(4-hydroxy-3-methyl)phenyl}propane and α,α′-bis(4-hydroxyphenyl)-m-diisopropylbenzene is preferably used.

Examples of the carbonating agent include carbonyl halides such as phosgene, carbonate esters such as diphenyl carbonate, haloformates such as dihaloformate of a dihydric phenol, etc. They may be used independently or as a mixture of two or more of them.

The methacrylic resin constituting the layer (B) is a polymer comprising a methacrylate. The methacrylic resin may be a homopolymer of a methacrylate or a copolymer of 50% by weight or more of a methacrylate and 50% by weight or less of a monomer other than the methacrylate. As the methacrylate, an alkyl methacrylate is generally used.

Preferably, the methacrylic resin comprises 50 to 100% by weight of an alkyl methacrylate, 0 to 50% by weight of an alkyl acrylate, and 0 to 49% by weight of a monomer other than the alkyl methacrylate and alkyl acrylate, based on the total weight of the monomers. More preferably, the methacrylic resin comprises 50 to 99.9% by weight of an alkyl methacrylate, 0.1 to 50% by weight of an alkyl acrylate, and 0 to 49% by weight of a monomer other than the alkyl methacrylate and alkyl acrylate, based on the total weight of the monomers.

The number of carbon atoms in the alkyl group of the alkyl methacrylate is preferably from 1 to 8, more preferably from 1 to 4. Specific examples of the alkyl methacrylate include methyl methacrylate, ethyl methacrylate, butyl methacrylate, 2-ethylhexyl methacrylate, etc. Among them, methyl methacrylate is preferably used.

The number of carbon atoms in the alkyl group of the alkyl acrylate is preferably from 1 to 8, more preferably from 1 to 4. Specific examples of the alkyl acrylate include methyl acrylate, ethyl acrylate, butyl acrylate, 2-ethylhexyl acrylate, etc.

The monomer other than the alkyl methacrylate and alkyl acrylate may be a monofunctional monomer, i.e., a compound having one polymerizable carbon-carbon double bond in a molecule, or a polyfunctional monomer, i.e. a compound having at least two polymerizable carbon-carbon double bonds in a molecule. Among them, the monofunctional monomer is preferably used. Examples of the monofunctional monomer include aromatic alkenyl compounds such as styrene, α-methylstyrene and vinyl toluene, alkenylcyanide compounds such as acrylonitrile and methacylonitrile, acrylic acid, methacrylic acid, maleic anhydride, N-substituted maleimide, etc. Examples of the polyfunctional monomer include polyunsaturated carboxylates of polyhydric alcohols such as ethylene glycol dimethacrylate, butanediol dimethacrylate and trimethylolpropane triacrylate, alkenyl esters of unsaturated carboxylic acids such as allyl acrylate, allyl methacrylate and allyl cinnamate, polyalkenyl esters of polybasic acids such as diallyl phthalate, diallyl maleate, triallyl cyanurate and triallyl isocyanurate, aromatic polyalkenyl compounds such as divinylbenzene, etc.

Optionally, two or more of the alkyl methacrylates, two or more of the alkyl acrylates and/or two or more of the monomers other than the alkyl methacrylate and alkyl acrylate may be used.

The methacrylic resin preferably has a glass transition temperature of 40° C. or higher, more preferably 60° C. or higher, from the viewpoint of the heat resistance of the layer (B). The glass transition temperature of the methacrylic resin may be appropriately adjusted by selecting the kinds of the monomers and the proportion thereof.

The methacrylic resin is prepared by polymerizing a monomer or monomers by a suitable polymerization method such as suspension polymerization, emulsion polymerization or bulk polymerization. In the polymerization, a chain transfer agent is preferably used in order for the methacrylic resin to have a suitable glass transition temperature or to have a viscosity suitable for moldability to form a multilayer film. The amount of the chain transfer agent may be appropriately selected according to the kinds of the monomers and the proportion thereof.

Preferably, the layer (B) is formed of a composition containing the methacrylic resin and the acrylic rubber particles in view of the flexibility of the multilayer film comprising such a layer (B). Here, as the rubber particles, particles of acrylic rubber, butadiene rubber or styrene-butadiene rubber may be use. Among them, the acrylic rubber particles are preferably used in view of the weather resistance.

The acrylic rubber particles contain an elastic polymer comprising an acrylate as a rubber component. The acrylic rubber particles may be particles with a single-layer structure consisting of the elastic polymer, or may be particles with a multilayer structure comprising at least one layer of the elastic polymer. The acrylic rubber particles preferably have a multilayer structure from the viewpoint of the surface hardness of the layer (B). The elastic polymer may be a homopolymer of an acrylate or a copolymer comprising 50% by weight or more of an acrylate and 50% by weight or less of other monomer. As the acrylate, an alkyl acrylate is preferably used.

Preferably, the elastic polymer comprising an acrylate comprises 50 to 99.9% by weight of an alkyl acrylate, 0 to 49.9% by weight of an alkyl methacrylate, 0 to 49.9% by weight of a monofunctional monomer other than the alkyl acrylate and alkyl methacrylate, and 0.1 to 10% by weight of a polyfunctional monomer, based on the total weight of the monomers.

Examples of the alkyl acrylate are the same as the alkyl acrylate exemplified as the monomer component of the methacrylic resin. The number of carbon atoms in the alkyl group is preferably from 1 to 8, more preferably 4 to 8. Examples of the alkyl methacrylate are also the same as the alkyl methacrylate exemplified as the monomer component of the methacrylic resin. The number of carbon atoms in the alkyl group is preferably from 1 to 8, more preferably 1 to 4.

Examples of the monofunctional monomer other than these monomers are the same as the monofunctional monomer other than alkyl methacrylate and alkyl acrylate exemplified as the monomer component of the methacrylic resin. Among them, an aromatic alkenyl compound such as styrene, α-methylstyrene or vinyl toluene is preferably used.

Examples of the polyfunctional monomer are the same as the polyfunctional monomer exemplified as the monomer component of the methacrylic resin. Among them, an alkenyl ester of an unsaturated carboxylic acid or a polyalkenyl ester of a polybasic acid is preferably used.

Optionally, two or more of the alkyl acrylates, two or more of the monofunctional monomers other than the alkyl acrylates, and/or two or more of the polyfunctional monomers may be used.

When the particles with a multilayer structure are used as the acrylic rubber particles, preference is given to particles with a multilayer structure having a layer of an elastic polymer comprising an acrylate and a layer of a polymer comprising a methacrylate which is formed around outside the layer of an elastic polymer, that is, particles having at least two layers, i.e., an inner layer of the elastic polymer comprising the acrylate and an outer layer of the polymer comprising the methacrylate. As the methacrylate used as the monomer component of the polymer for the outer layer, an alkyl methacrylate is preferably used. The polymer for the outer layer is preferably used in an amount of 10 to 400 parts by weight, more preferably 20 to 200 parts by weight, per 100 parts by weight of the elastic polymer for the inner layer. When 10 parts by weight or more of the polymer for the outer layer is used per 100 parts by weight of the elastic polymer for the inner layer, the elastic polymer particles hardly agglomerate, so that the transparency of the layer (B) is improved.

Preferably, the polymer for the outer layer comprises 50 to 100% by weight of an alkyl methacrylate, 0 to 50% by weight of an alkyl acrylate, 0 to 50% by weight of a monomer other than the alkyl methacrylate and alkyl acrylate, and 0 to 10% by weight of a polyfunctional monomer, based on the total weight of the monomers.

Examples of the alkyl methacrylate are the same as the alkyl methacrylate exemplified as the monomer component of the methacrylic resin. The number of carbon atoms in the alkyl group is preferably from 1 to 8, more preferably from 1 to 4. Among them, methyl methacrylate is preferably used.

Examples of the alkyl acrylate are the same as the alkyl acrylate exemplified as the monomer component of the methacrylic resin. The number of carbon atoms in the alkyl group is preferably from 1 to 8, more preferably from 1 to 4.

Examples of the monomer other than the alkyl methacrylate and alkyl acrylate are the same as the monofunctional monomer other than the alkyl methacrylate and alkyl acrylate exemplified as the monomer component of the methacrylic resin. Examples of the polyfunctional monomer are the same as the polyfunctional monomer exemplified as the monomer component of the methacrylic resin.

Optionally, two or more of the alkyl methacrylates, two or more of the alkyl acrylates, two or more of the monofunctional monomers other than the alkyl methacrylates and alkyl acrylates, and/or two or more of the polyfunctional monomers may be used.

A further example of the rubber particles with a multilayer structure are rubber particles with a multilayer structure having at least three layers, that is, an inner layer of a polymer comprising a methacrylate, an intermediate layer of an elastic polymer comprising an acrylate and an outer layer of a polymer comprising a methacrylate. In other words, the particles having such a multilayer structure are the modification of the particles with a two-layer structure by forming a further layer of a polymer comprising a methacrylate inside the inner layer of the two-layer structure. As the methacrylate as the monomer component of the polymer for the inner layer, an alkyl methacrylate is preferably used. The polymer for the inner layer is preferably used in an amount of from 10 to 400 parts by weight, more preferably from 20 to 200 parts by weight, per 100 parts by weight of the elastic polymer for the intermediate layer.

The polymer for the inner layer preferably comprises 70 to 100% by weight of an alkyl methacrylate, 0 to 30% by weight of an alkyl acrylate, 0 to 30% by weight of a monomer other than the alkyl methacrylate and alkyl acrylate, and 0 to 10% by weight of a polyfunctional monomer, based on the total weight of the monomers.

Examples of the alkyl methacrylate are the same as the alkyl methacrylate exemplified as the monomer component of the methacrylic resin. The number of carbon atoms in the alkyl group is preferably from 1 to 8, more preferably from 1 to 4. Among them, methyl methacrylate is preferably used. Examples of the alkyl acrylate are the same as the alkyl acrylate exemplified as the monomer component of the methacrylic resin The number of carbon atoms in the alkyl group is preferably from 1 to 8, more preferably from 1 to 4.

Examples of the monomer other than alkyl methacrylate and alkyl acrylate are the same as the monofunctional monomer other than the alkyl methacrylate and alkyl acrylate exemplified as the monomer component of the methacrylic resin. Examples of the polyfunctional monomer are the same as the polyfunctional monomer exemplified as the monomer component of the methacrylic resin.

Optionally, two or more of the alkyl methacrylates, and/or two or more of the monomers other than the alkyl methacrylates may be used.

The acrylic rubber particles may be prepared as follows: the monomer components of the elastic polymer comprising the acrylate are polymerized in at least one step of reaction by emulsion polymerization or the like. When the layer of the polymer comprising the methacrylate is formed on the outer surface of the layer of the elastic polymer as described above, the monomer components of the polymer for this outer layer are polymerized in at least one step of reaction in the presence of the elastic polymer by emulsion polymerization or the like, to graft the resultant polymer on the elastic polymer. When the layer of the polymer comprising the methacrylate is additionally present inside the layer of the elastic polymer as described above, firstly, the monomer components of the polymer for this inner layer are polymerized in at least one step of reaction by emulsion polymerization or the like; then, the monomer components of the elastic polymer are polymerized in at least one step of reaction in the presence of the resultant polymer by emulsion polymerization or the like, to graft the resultant elastic polymer on the polymer for the inner layer; and then the monomer components of the polymer for the outer layer are polymerized in at least one step of reaction in the presence of the resultant elastic polymer by emulsion polymerization or the like, to graft the resultant polymer on the elastic polymer. When the polymerization for each layer is carried out in two or more steps of reactions, the monomer composition of each layer as a whole, but not the monomer composition in each reaction step, should fall within the above-specified range.

For the acrylic rubber particles, the average particle size of the layer of the elastic polymer comprising the acrylate is preferably from 0.01 to 0.4 μm, more preferably from 0.05 to 0.3 μm, still more preferably from 0.07 to 0.25 μm. When this average particle size is too large, the transparency of the layer (B) undesirably tends to decrease. When this average particle size is too small, the surface hardness of the layer (B) undesirably tends to deteriorate, and the layer (B) is easily flawed and has degraded flexibility so that it is easily cracked.

This average particle size is determined as follows: the acrylic rubber particles are mixed with the methacrylic resin to form a film; the layer of the elastic polymer in the section of the film is dyed with ruthenium oxide; and the section of the film is observed with an electron microscope to find the diameter of the dyed portion. This method is described in more detail: when the section of the film formed of the mixture of the acrylic rubber particles and the methacrylic resin is dyed with ruthenium oxide, the methacrylic resin as a matrix is not dyed. In addition, when a layer of a polymer comprising a methacrylate is present outside the layer of the elastic polymer, the polymer of this outer layer is not dyed either. As a result, only the layer of the elastic polymer is dyed, which makes it possible to determine the particle size from the diameter of the substantially circular dyed portion observed with the electron microscope. When a layer of a polymer comprising a methacrylate is present inside the layer of the above-described elastic polymer, this inner layer is not dyed either, so that each particle is observed as if it has a two-layer structure in which the layer of the elastic polymer outside the inner layer is dyed. In this case, the particle diameter may be determined from the outer diameter of the outer layer of the two-layer structure, i.e., the layer of the elastic polymer.

The amounts of the methacrylic resin and the rubber particles are 40 to 100 parts by weight and 0 to 60 parts by weight, respectively, per 100 parts by weight of the total weight of them. When the amount of the methacrylic resin is too small while the amount of the rubber particles is too large, not only the whitening tends to occur on bending or molding, but also the surface hardness of the film tends to deteriorate so that the film is easily scratched, which results in the poor appearance of the articles after transferring a shape to the article. If the film has sufficient strength without blending the rubber particles, the film may not necessarily contain the rubber particles. Particularly, when an in-mold method comprising molding a decorated matte laminate film in an injection mold and then integrating the film with a thermoplastic resin by injection molding in the same mold is employed, the rubber particles may be compounded in an amount of, for example, 16 parts by weight or more, since the whitening due to the deformation or bending of the film hardly occurs. On the other hand, when an insert molding method comprising pre-molding the film with other mold in a thermoforming apparatus, inserting the pre-molded film in an injection mold, and the integrating the film with a thermoplastic resin is employed, preferably the rubber particles are not contained or they are compounded in an amount 15% or less if they are contained, since the whitening easily occurs in the case of deforming or bending the film.

The methacrylic resin constituting the layer (B) may optionally contain other components or additives, for example, a UV absorber, an organic dye, an inorganic dye, a pigment, an antioxidant, an antistatic agent, a surfactant, etc. besides the rubber particles.

The multilayer film which constitutes the transparent resin film substrate of the matte laminate film of the present invention may be produced by forming the layer (B) formed of the methacrylic resin on at least one surface of the layer (A) formed of the polycarbonate resin through the lamination of the polycarbonate resin constituting the layer (B) and the methacrylic resin constituting the layer (A). A method for producing the laminate film may be appropriately selected. For example, the following methods are advantageously employed: a co-extrusion method in which the resins of the respective layers are molten with extruders, respectively, and the resulting melts are then co-extruded and laminated on each other by a feed block method or a multimanifold method; or a polycarbonate resin is formed into a film by extrusion, and the resulting film is coated on its surface with the composition of the methacrylic resin and optionally the acrylic rubber particles which may optionally be dissolved in a solvent. Of these methods, the co-extrusion method is preferably employed.

In the co-extrusion method, the co-extruded resin melts are contacted to rolls or belts to form a film. The number of the rolls or the belts, the arrangement thereof and the materials thereof are not limited. However, the following method is preferable in which the resin melts are allowed to pass through a gap between two metal rolls or between a metal roll and a metal belt to contact the resin melts to the metal roll and/or the metal belt, so as to transfer a pattern carved on the surface of the roll or the belt to the surface of the resin film formed. This method is preferable because the profile accuracy of the surface of the film is improved to enhance the decorative property of the film. Alternatively, the surface of a metal roll and the surface of an elastic metal roll are allowed to contact to the both surfaces of the co-extruded resin melts. This method is advantageous to reduce the strain of the resulting film during the molding and to reduce anisotropy in strength and thermal shrinkage of the film. For example, the elastic metal roll comprises a shaft roll and a cylindrical metallic thin layer which is arranged to cover the outer circumference of the shaft roll and to which the resin melt contacts, wherein a fluid such as water or an oil, the temperature of which is controlled, is sealed between the shaft roll and the metallic thin layer, or the elastic metal roll comprises a rubber roll the surface of which is wrapped with a metal belt.

The multilayer film thus obtained preferably has a thickness of from 20 to 200 μm, more preferably from 30 to 150 μm, still more preferably from 50 to 100 μm. A multilayer film having a too large thickness requires a long time in a molding process for producing an interior material for automobiles, and is low in effect to improve the physical properties and designability thereof, and increases costs. On the other hand, a multilayer film having a too small thickness is difficult to form by extrusion because of the restriction on machinery, and has lower strength at break, and the probability to cause failures in manufacturing increases. The thickness of the multilayer film can be controlled by adjusting a film-forming speed, the thickness of a discharge port of a T die or the gap between rolls.

The layer (B) formed of the methacrylic resin may be formed on only one surface of the layer (A) formed of the polycarbonate resin, or on both surfaces of the layer (A). Preferably, the layers (B) are formed on the both surfaces of the layer (A) in view of the properties of the methacrylic resin such as surface hardness, gloss and printing property).

The thickness of the layer (A) formed of the polycarbonate resin is preferably from 10 to 80% of the total thickness of the multilayer film, that is the total thickness of the transparent resin film substrate of the matte laminate film of the present invention. When the layer (A) is too thin, the resultant multilayer film becomes fragile and cracky. The thickness of the layer (B) formed of the composition of the methacrylic resin and the acrylic rubber particles is preferably 10 μm or more, more preferably 15 μm or more, still more preferably 20 μm or more. When the layer (B) is too thin, the surface hardness of the resultant film decreases. When the layers (B) are laminated on the both surfaces of the layer (A), the thickness of each layer (B) is preferably 10 μm or more, more preferably 15 μm or more, still more preferably 20 μm or more.

The matte laminate film can be produced by forming a matte layer on at least one surface of the resulting transparent resin film substrate. The matte layer may comprise a cured product of a thermosetting resin and fine particles dispersed therein, or a cured product of a photocurable resin and fine particles dispersed therein, or a thermoplastic resin and fine particles dispersed therein.

With respect to the fine particles, the kind, particle size and spherical shape thereof are not particularly limited as long as they can attain sufficient matte appearance. Examples of the fine particles include inorganic particles such as silica, mica, calcium carbonate, magnesium carbonate and titanium oxide; inorganic particles which are surface-treated with acrylic resins, polyurethane resins or surfactants; crosslinked organic resin particles which are formed by copolymerizing an alkyl acrylate or methacrylate or an aromatic vinyl compound with a compound having one polymerizable functional group which is copolymerized with these compounds and further with a compound having two or more polymerizable functional groups which are copolymerized with these compounds; etc. Among them, silica or crosslinked organic resin particles are preferably used from the viewpoint of the particle shape or size. The particle size of the fine particles is preferably from 0.1 to 20 μm, more preferably from 0.5 to 10 μm. When the fine particles are too small, matte appearance is unsatisfactory. When the fine particles are too large, unevenness of the surface increases, resulting in not only the deterioration of the appearance of the matte laminate film but also the deterioration of transparency of the matte laminate film.

Examples of the thermosetting resin or photocurable resin include acrylic resins, epoxy resins, ester resins, urethane resins, urethane acrylate resins, silicone acrylate resins, etc. Among them, urethane resins and urethane acrylate resins are preferably used in view of followability to the expansion of the film substrate.

Examples of the urethane acrylate resin include an urethane acrylate thermosetting resin comprising a hydroxyl group-containing acrylate resin, which is produced by copolymerizing an alkyl (meth)acrylate (e.g., methyl (meth)acrylate, ethyl (meth)acrylate, propyl (meth)acrylate and butyl (meth)acrylate) and a hydroxyalkyl (meth)arylate (e.g., hydroxyethyl (meth)arylate, hydroxypropyl (meth)arylate and hydroxybutyl (meth)arylate), and a polyisocyanate compound (e.g., tolylene diisocyanate, xylene diisocyanate, diphenylmethane diisocyanate, hexamethylene diisocyanate and an adduct produced by a partial addition reaction of these isocyanate compounds with a polyol); and an urethane acrylate photocurable resin (a mixture with a (meth)acrylate monomer having an unreacted hydroxyl group) prepared by reacting a compound having at least one isocyanate group in a molecule with a hydroxyl group-containing (meth)acrylate monomer in amounts such that the hydroxyl groups is at least equimolar to the isocyanate groups.

Examples of the urethane resin include a thermosetting resin comprising a polyol compound (e.g., cellulose resins, polyether polyol resins, polyester polyol resins, polycarbonate polyol resins, polycaprolactone polyol resins and the hydroxyl group-containing acrylate resins described above) and the polyisocyanate compound described above.

When the urethane acrylate photocurable resin is cured with light, a photopolymerization initiator is used. Examples of the photopolymerization initiator include benzil, benzophenone and derivative thereof, thioxanthones, benzyl dimethyl ketals, α-hydroxyalkylphenones, hydroxyketones, aminoalkylphenones, acylphosphine oxides, etc. The amount of the photopolymerization initiator to be added is usually from 0.1 to 5 parts by weight per 100 parts by weight of the curable compound.

As the thermoplastic resin, those soluble in a solvent are preferably used. Examples of the thermoplastic resin include acrylic resins (e.g., methacrylic resins), polyester resins, polycarbonate resins, polycyclic olefin resins, acrylonitrile-butadine-styrene copolymers (ABS resin), polyvinilidene fluoride resins (PVDF resin), etc. The kind of the thermoplastic resin may be appropriately selected depending on the applications of the resulting matte laminate films. For example, in the application for surface decoration, a highly transparent resin, in particular, a methacrylic resin is preferably used. Among them, an acrylic resin is preferable in that copolymers of a variety of alkyl acrylates or alkyl methacrylates can make a designation of various resin properties.

The thermosetting resin may be mixed with fine particles and optional additives or solvents to obtain a thermosetting coating composition. Particularly, in the case of a thermosetting urethane or urethane acrylate resin, a polyol compound and a polyisocyanate are provided as independent compositions and the compositions are preferably mixed together just before use, since the mixing of the polyol compound and the polyisocyanate immediately initiate the reaction of them. Similarly, the thermoplastic resin may also be mixed with fine particles, optional various additives or solvents to obtain a coating composition.

Besides the photopolymerization initiators, examples of the additives include reaction catalysts, leveling agents, colorants, dyes, pigments, lubricants, waxes, photostabilizers, ultraviolet absorbents, antioxidants, defoaming agents, precipitation inhibitors for particles, viscosity regulators, etc.

Among them, the leveling agent is preferably used so as to prevent unevenness or streak defects on a coating film and to make a surface condition clean and beautiful. Examples of the leveling agent include silicone oils and organic polymers. The conventional silicone oil may be used, and specific examples thereof include dimethyl silicone oil, phenylmethyl silicone oil, alkyl/aralkyl modified silicone oil, fluorosilicone oil, polyether modified silicone oil, fatty acid ester modified silicone oil, methyl hydrogen silicone oil, silanol group-containing silicone oil, alkoxyl group-containing silicone oil, phenol group-containing silicone oil, methacryl modified silicone oil, amino modified silicone oil, carboxylic acid modified silicone oil, carbinol modified silicone oil, epoxy modified silicone oil, mercapto modified silicone oil, fluorine modified silicone oil, polyether modified silicone oil, etc. These leveling agents are commercially available. Examples of the commercially available leveling agent include such as “SH200-100cs”, “SH28PA”, “SH29PA”, “SH30PA”, “ST83PA”, “ST80PA”, “ST97PA”, and “ST86PA” (all manufactured by Dow Corning Toray Silicone Co., Ltd.). These leveling agents may be used singly or as a mixture of two or more of them. The amount of the leveling agent used may be selected depending on the properties of the coating composition and it is usually about 0.01 to 10 parts by weight per 100 parts by weight of the resin.

The solvent is not particularly limited as long as it can dissolve resins or various additives and can be evaporated off after the application of the coating composition. Examples of the solvent include ketones such as acetone, methyl ethyl ketone, methyl isobutyl ketone and diacetone alcohol, aromatic hydrocarbons such as toluene and xylene, esters such as ethyl acetate and butyl acetate, alcohols such as diacetone alcohol, methanol, ethanol, isopropyl alcohol, isobutyl alcohol, 2-methoxyethanol, 2-ethoxyethanol, 2-butoxyethanol and 1-methoxy-2-propanol, water, etc. The amount of the solvent in the coating composition is not particularly limited. The solvent may be used in an appropriate amount depending on the properties of the resins.

The matte layer may be formed by preparing the coating composition and applying it to the surface of the transparent resin film substrate on which the matte layer will be formed. The various conventional methods such as die coating, gravure coating, gravure reverse coating, micro gravure coating, roll coating, comma roll coating, reverse roll coating, blade coating, dip coating, flow coating, bar coating, curtain coating method, and the air knife coating method may be employed in the application. Among them, gravure coating, gravure reverse coating and micro gravure coating are preferably used because of their little influence on the film winding state and of uniform coating of the coating composition.

A gravure roll may be used in the gravure coating. The number of lines per one inch of the gravure roll may be appropriately selected depending on the thickness of the coating film, and it is usually from 100 lines to 1000 lines per inch. An angle between the direction of the diagonal line on the roll and the roll may be appropriately selected depending on the coating finish and it is usually 35 to 55°.

The applied coating composition may optionally be dried to evaporate the solvent off and then, in the case of a thermosetting resin, it is cured by heating, or in the case of a photocurable resin, it is cured by irradiation with ultraviolet ray, thereby to form a matte layer. When a thermoplastic resin is used, the matter layer can be formed only by evaporation the solvent off.

The drying temperature is not particularly limited and it is usually from 40 to 100° C. The drying time is suitably selected and it is usually from several seconds to 15 minutes. In the case of a thermosetting resin, the removal of the solvent and curing of the resin may be simultaneously performed, or heat-treatment may be further performed after applying the coating composition, heat-drying the solvent to evaporate it and winding the matte laminate film. In this case, the heating temperature and time are also suitably selected and adjusted such that the thermosetting reaction is completed within a treatment time, and the conditions are usually set within a temperature range of 40 to 100° C. and a time period of 1 to 100 hours. The heating method may be suitably selected. If the coated film is in a state prior to winding, a heating method comprising passing the film through an oven, a heating method comprising hot air-blowing, or a heating method comprising heating by radiation heat using a heater such as an IR heater may be exemplified. In addition, after the matte laminate film is wound, a method of allowing the film to stand in a circulating hot air oven may be possible.

The matte layer is usually has a thickness of about 1 to 20 μm. The matte layer should maintain its designability even if it is subjected as a decorative film to a simultaneous injection molding-lamination method while retaining its designability. Thus, it is preferable that no defect such as crack or breakage generates in the matte layer even after the film is stretched 50% at 120° C.

In the matte laminate film, when the matte layer is formed on one surface of the transparent resin film substrate, a pattern may be printed on the other surface of the substrate, or designability may be imparted to the transparent resin film substrate itself by coloring. In a case where the matte layers are formed on both surfaces of the transparent resin film substrate, again designability may be imparted to the transparent resin film substrate itself by coloring. Since the matte laminate film has excellent moldability, it is preferable from the viewpoint of the retention of matting performance upon molding and it is preferably used in the surface coating method including the simultaneous injection molding-lamination method.

Further, the matte laminate film may have a pressure-sensitive adhesive layer, an adhesive layer or the like on one surface thereof and such layer may be formed easily by applying a pressure-sensitive adhesive or an adhesive on the desired surface of the matte laminate film. In a case where a matte layer is formed on one surface of the transparent resin film substrate, a pressure-sensitive adhesive layer or an adhesive layer may be formed on the surface of the matte layer, or on the opposite smooth surface having no matte layer In general, it is advantageous to form a pressure-sensitive adhesive layer or an adhesive layer on the opposite surface to the matte layer.

The matte laminate film of the present invention is preferably used as a decorative film. In view of a decorative property and a surface hardness of the resultant product, preferably, the matte laminate film comprises the transparent resin film substrate having the layers (B) formed of the methacrylic resin, which are formed on the both surfaces of the layer (A) formed of the polycarbonate resin, or the matte laminate film has the matter layer on one surface of the transparent resin film substrate and the decoration on the other surface of the transparent resin film substrate. As decorating means, the following methods are exemplified: a method of directly printing a wood-grain design or any other various designs on the surface of the multilayer film by continuous gravure printing, silk screen printing, etc.; a method of imparting a metal-plating like design to the surface of the multilayer film by a vapor deposition process or a sputtering process; or a method of laminating, on the multilayer film, other resin film having a decorative pattern formed thereon by printing or vapor deposition.

Further, a decorative sheet can be provided by laminating a thermoplastic resin sheet as a backing material on the printed or other decorative pattern-formed surface of the decorative film. Examples of a resin constituting the thermoplastic resin sheet include ABS resins, methacrylic resins, polyvinyl chloride resins, polyurethane resins, polyester resins, polyolefin resins, etc. The thickness of the thermoplastic resin sheet includes a film-range thickness and is preferably from about 0.1 to about 2 mm.

Then, the decorative film or sheet thus obtained is laminated on a molded article of a thermoplastic resin so that the matte layer is located on the surface side. Specifically, in case of the decorative film, the molded article of the thermoplastic resin is laminated on the decorative surface of the film. In case of the decorative sheet, the molded article of the thermoplastic resin is laminated on a surface of the decorative sheet on which the thermoplastic resin sheet is laminated. Thereby, a decorative molded article with matte appearance can be provided. Examples of the thermoplastic resin constituting the molded article include ABS resins, methacrylic resins, polyvinyl chloride resins, polyurethane resins, polyester resins, polyolefin resins, etc.

As a method for producing a decorative molded article, a simultaneous injection molding-lamination method is advantageously employed. For example, this method is carried out as follows: the decorative film or sheet which has not been pre-molded is inserted in an injection mold, and a resin melt is injected into the mold to form an injection-molded article with simultaneously laminating the decorative film or sheet on the molded article (sometimes referred to as a narrowly-defined simultaneous injection molding-lamination method); or the decorative film or sheet is pre-molded by vacuum forming or pressure forming and then inserted in an injection mold, and a resin melt is injected into the mold to form an injection-molded article with simultaneously laminating the decorative film or sheet on the molded article (referred to as an insert molding method); or the decorative film or sheet is pre-molded in an injection mold by vacuum forming or pressure forming, and a resin melt is then injected into the mold to form an injection-molded article with simultaneously laminating the decorative film or sheet on the molded article (referred to as an in-mold molding method). The simultaneous injection molding-lamination method is described in detail, for example, in JP-B-63-6339, JP-B-4-9647 and JP-A-7-9484.

### EXAMPLES

Hereinafter, the present invention will be illustrated with reference to the Examples, which they do not limit the scope of the present invention in any way. In Examples, “%” and “parts” indicating contents or amounts are by weight, unless otherwise specified.

As a methacrylic resin, there were used pellets of a thermoplastic polymer (glass transition temperature: 104° C.) prepared by bulk polymerization of a monomer mixture containing 97.8% of methyl methacrylate and 2.2% of methyl acrylate. Here, the glass transition temperature was an extrapolated glass transition-starting temperature which was determined at a heating rate of 10° C./min. by differential scanning calorimetry according to JIS K7121: 1987.

Acrylic rubber particles (A) used were spherical rubber particles with a three-layer structure produced by the emulsion polymerization method, each particle having an innermost layer formed of a hard polymer prepared by polymerization of a monomer mixture containing 93.8% of methyl methacrylate, 6% of methyl acrylate and 0.2% of allyl methacrylate; an intermediate layer formed of an elastic polymer prepared by polymerization of a monomer mixture containing 81% of butyl acrylate, 17% of styrene and 2% of allyl methacrylate; and an outermost layer formed of a hard polymer prepared by polymerization of a monomer mixture containing 94% of methyl methacrylate and 6% of methyl acrylate, in which the weight ratio of the innermost layer/the intermediate layer/the outermost layer was 35/45/20; and the average particle size of the intermediate elastic polymer layer was 0.22 μm.

Acrylic rubber particles (B) used were spherical rubber particles with a two-layer structure produced by the emulsion polymerization method, each particle having an inner layer formed of an elastic polymer prepared by polymerization of a monomer mixture containing 81% of butyl acrylate, 17% of styrene and 2% of allyl methacrylate; and an outer layer formed of a hard polymer prepared by polymerization of a monomer mixture containing 94% of methyl methacrylate and 6% of methyl acrylate, in which the weight ratio of the inner layer/the outer layer was 80/20; and the average particle size of the inner elastic polymer layer was 0.08 μm.

The average particle sizes of the elastic polymer layers of the acrylic rubber particles (A) and (B) were measured by the following method.

Measurement of Average Particle Size of Elastic Polymer Layer

A film was formed from a mixture of the acrylic rubber particles and the methacrylic resin, and was cut into pieces with appropriate sizes. The piece of the film was immersed in a 0.5% aqueous solution of ruthenium tetraoxide at room temperature for 15 hours to dye the elastic copolymer layers of the rubber particles. The film sample was cut with a microtome to obtain a sample piece with a thickness of about 80 nm, which was then photographed using a transmission electron microscope. From this photograph, 100 dyed elastic copolymer layers were randomly selected, and the particle sizes of the selected layers were calculated. A number-average particle size was used as an average particle size.

As a polycarbonate resin, CALIBRE 301-10 (available from Sumitomo Dow Limited) was used.

Preparation of Matte Paint (1)

Twenty-three parts of an acrylate resin of methyl methacrylate/butyl acrylate/hydroxyethyl methacrylate copolymer having hydroxyl groups (molecular weight: about 40,000; hydroxyl value: 70 mg KOH/g), 4.5 parts of amorphous silica particles with an average particle size of 4 μm, 6 parts of an tolylene diisocyanate adduct, 16.5 parts of methyl ethyl ketone, 20 parts of ethyl acetate and 30 parts of toluene were mixed to prepare a matte paint (1).

Preparation of Matte Paint (2)

Twenty-nine parts of an urethane acrylate compound (U-200AX manufactured by Shin-Nakamura Chemical Co., Ltd.), 4.5 parts of amorphous silica particles with an average particle size of 4 μm, 2 parts of a photopolymerization initiator (IRGACURE 184 manufactured by Ciba Specialty Chemicals Inc.), 14.5 parts of methyl ethyl ketone, 20 parts of ethyl acetate and 30 parts of toluene were mixed to prepare a matte paint (2).

Preparation of Matte Paint (3)

Sixty-seven and a half parts of a solution of an acrylic polymer having a weight average molecular weight of 91,000 and a number average molecular weight of 83,000 (ACRYBASE LH101D manufactured by Fujikura Kasei Co., Ltd.), 4.5 parts of amorphous silica particles with an average particle size of 4 μm, 15 parts of ethyl acetate and 13 parts of toluene were mixed to prepare a matte paint (3).

### Examples 1, 4 and 5

The pellets of the methacrylic resin and the acrylic rubber particles (A) or (B) were mixed in the ratio shown in Table 1 with a SUPER MIXER, and the mixture was melt-kneaded in a twin-screw extruder to obtain pellets of a methacrylic resin composition (used in Examples 4 and 5). Then, the pellets of the polycarbonate resin were molten in a 65 mmφ single screw extruder (manufactured by Toshiba Machine Co., Ltd.), and the pellets of the methacrylic resin (Example 1) or of the methacrylic resin composition (Examples 4 and 5) were molten in a 45 mmφ single screw extruder (manufactured by Toshiba Machine Co., Ltd.). The respective melts were laminated on and integrated each other by the feed block method, and the integrated laminate was extruded through a T-die set at 275° C. to obtain a film-form material. This film-form material was sandwiched between a pair of metal rolls having smooth surfaces so as to shape the film-form material. Thus, a multilayer film with a three-layer structure having a total thickness of 75 μm was obtained.

The matte paint (1) was applied to one surface of the resulting laminate film using a No. 6 bar coater, and the film was dried in a circulating hot air oven at 40° C. for 3 minutes, followed by drying in the circulating hot air oven at 50° C. for 24 hours to complete the thermosetting reaction. Thereby, a mat resin layer having a thickness of 3 to 5 μm was formed. The resulting matte laminate film was subjected to the following evaluations. The results are shown in Table 1.

Total Light Transmission (Tt)

A total light transmission was measured according to JIS K7361-1.

Haze

A haze was measured according to JIS K7136.

Gloss

The gloss on the surface of the matte layer was measured according to JIS K7105.

Pencil Hardness

The pencil hardness of the surface of the matte layer was measured according to JIS K5600.

Tensile Test

A test piece of 10 mm in width and 100 mm in length was provided and a tensile test was carried out with a tensile tester at a tension rate of 50 mm/min. at a chuck distance 50 mm under an atmosphere kept at a temperature of 150° C. When the chuck distance reached 75 mm, the pulling was stopped and the test piece was removed from the tester. The surface condition of the matte layer was observed with an eye and ranked as follows:
A: No occurrence of poor appearance such as crack or breakage
B: Occurrence of poor appearance such as crack or breakage

Simultaneous Injection Molding-Lamination Test

The resultant film was cut to obtain a film piece of 15 cm×25 cm. This film piece was applied to the stationary part of an injection mold for molding a flat plate having a thickness (or depth) of 3 mm and a size of 12 cm×20 cm, so that the film piece run off the edges of the mold cavity. The mold was closed, and then, a methacrylic resin (Sumipex MH manufactured by Sumitomo Chemical Company, Limited) was injected with an injection-molding machine (IS130FII-3AV, manufactured by Toshiba Machine Co., Ltd.) on the surface of the film opposite to the matte layer. The temperature of the injection mold was 60° C.; the temperature of the methacrylic resin was 24.5° C.; the injection pressure was 32%; and the cooling time was 40 seconds.

The appearance of the corner parts of the molded article were observed with an eye, and evaluated according to the following criteria:

A: no whitening occurred

B: slight whitening occurred

C: remarkable whitening occurred

The portion of the film running off the cavity edge was folded along the boundary with the injection-molded portion of the film, and the condition of the bent portion of the film was observed. The film was evaluated according to the following criteria:
A: neither cracking nor peeling was observed in the film
B: no peeling of the film occurred, but cracking occurred
C: no cracking of the film occurred, but peeling occurred

### Example 2

The pellets of the polycarbonate resin were molten in a 65 mmφ single screw extruder (manufactured by Toshiba Machine Co., Ltd.), and the pellets of the methacrylic resin were molten in a 45 mmφ single screw extruder (manufactured by Toshiba Machine Co., Ltd.). The respective melts were laminated on and integrated each other by the feed block method, and the integrated laminate was extruded through a T-die set at 275° C. to obtain a film-form material. This film-form material was sandwiched between a pair of metal rolls having smooth surfaces so as to shape the film-form material. Thus, a multilayer film with a three-layer structure having a total thickness of 75 μm was obtained.

The matte paint (2) was applied to one surface of the resulting laminate film by using a No. 6 bar coater and dried in a circulating hot air oven at 40° C. for 3 minutes. Then, the matte paint was cured by ultraviolet irradiation at 0.5 J/cm² with a 120 W high-pressure mercury lamp, thereby forming a matte layer having a thickness of 3 to 5 μm. The resulting matte laminate film was subjected to the same evaluations as in Examples 1, 4 and 5. The results are shown in Table 1.

### Example 3

The pellets of the polycarbonate resin were molten in a 65 mmφ single screw extruder (manufactured by Toshiba Machine Co., Ltd.), and the pellets of the methacrylic resin were molten in a 45 mmφ single screw extruder (manufactured by Toshiba Machine Co., Ltd.). The respective melts were laminated on and integrated each other by the feed block method, and the integrated laminate was extruded through a T-die set at 275° C. to obtain a film-form material. This film-form material was sandwiched between a pair of metal rolls having smooth surfaces so as to shape the film-form material. Thus, a multilayer film with a three-layer structure having a total thickness of 75 μm was obtained.

The matte paint (3) was applied to one surface of the resulting laminate film using a No. 6 bar coater, and the film was dried in a circulating hot air oven at 40° C. for 3 minutes, followed by drying in a circulating hot air oven at 50° C. for 24 hours to complete the thermosetting reaction, thereby to form a mat resin layer having a thickness of 3 to 5 μm. The resulting matte laminate film was subjected to the same evaluations as in Examples 1, 4 and 5. The results are shown in Table 1.

### Comparative Examples 1-2

The pellets of the methacrylic resin and the acrylic rubber particles (A) or (B) were mixed in the ratio shown in Table 1 with a SUPER MIXER, and the mixture was melt-kneaded in a twin-screw extruder to obtain pellets of a methacrylic resin composition. Then, the pellets of the methacrylic resin composition were molten in a 65 mmφ single screw extruder (manufactured by Toshiba Machine Co., Ltd.), and the melt was extruded through a T die set at 275° C. to obtain a film-form material. This film-form material was sandwiched between a pair of metal rolls having smooth surfaces so as to shape the film-form material. Thus, a single-layer methacrylic resin film with a thickness of 75 μm was obtained. On this resin film, a matte layer having a thickness of 3 to 5 mm was formed in the same manner as in Example 1. The resulting matte laminate film was subjected to the same evaluations as in Examples 1, 4 and 5. The results are shown in Table 1.

### Comparative Example 3

The pellets of a polycarbonate resin were molten in a 65 mmφ single screw extruder (manufactured by TOSHIBA MACHINE CO., LTD.) and the melt was extruded through a T die set at 275° C., and the resulting film-form material was sandwiched between a pair of metal rolls having smooth surfaces so as to shape the film-form material. Thus, a single-layer polycarbonate resin film with a thickness of 75 μm was obtained. On this resin film, a matte layer having a thickness of 3 to 5 mm was formed in the same manner as in Example 1. The resulting matte laminate film was subjected to the same evaluations as in Examples 1, 4 and 5. The results are shown in Table 1.

TABLE 1

| | Layer (B) | | | Thicknesses | | | | | | | | |
|---|---|---|---|---|---|---|---|---|---|---|---|---|
| | Methacrylic | Acrylic Rubber | | of Layers | | | | | | | Injection Molding | |
| Example | Resin | Particle | | (B)/(A)/(B) | Matte | Tt | Haze | Gloss | Pencil | Tensile | Whitening | Bending |
| No. | (Parts) | Kind | Parts | (μm/μm/μm) | Paint | (%) | (%) | (%) | Hardness | Test | at Corners | Test |
| Ex. 1 | 100 | — | — | 15/45/15 | (1) | 89.0 | 55.2 | 22.8 | H | A | A | A |
| Ex. 2 | 100 | — | — | 15/45/15 | (2) | 87.1 | 58.3 | 19.8 | HB | A | A | A |
| Ex. 3 | 100 | — | — | 15/45/15 | (3) | 89.2 | 54.9 | 20.2 | HB | A | A | A |
| Ex. 4 | 80 | (A) | 20 | 15/45/15 | (1) | 88.7 | 55.4 | 23.1 | F | A | B | A |
| Ex. 5 | 70 | (B) | 30 | 15/45/15 | (1) | 88.9 | 54.3 | 22.5 | HB | A | A | A |
| C. Ex. 1 | 80 | (A) | 20 | 75/—/— | (1) | 88.4 | 55.6 | 22.1 | F | A | C | C |
| C. Ex. 2 | 70 | (B) | 30 | 75/—/— | (1) | 89.1 | 54.5 | 21.7 | HB | A | A | B |
| C. Ex. 3 | — | — | | —/75/— | (1) | 87.8 | 56.1 | 23.0 | 5B | A | A | C |

What is claimed is:

1. A method for producing a matte laminate film which comprises a transparent resin film substrate, wherein said transparent resin film substrate is a laminate film comprising a layer (A) formed of a polycarbonate resin and a layer (B) formed of a methacrylic resin that is laminated on at least one surface of the layer (A), and a matte layer formed on at least one surface of the transparent resin film substrate, said method comprising the steps of:
co-extruding a polycarbonate resin and a methacrylic resin to form the laminate film as the transparent resin film substrate; and
forming the matte layer on at least one surface of the transparent resin film substrate.

2. The method according to claim 1, wherein the methacrylic resin is a polymer prepared by polymerizing 50 to 100% by weight of an alkyl methacrylate, 0 to 50% by weight of an alkyl acrylate, and 0 to 49% by weight of a monomer other than the alkyl methacrylate and alkyl acrylate.

3. The method according to claim 1, wherein the layer (B) contains rubber particles.

4. The method according to claim 3, wherein said rubber particles are acrylic rubber particles.

5. The method according to claim 4, wherein the acrylic rubber particles comprise an elastic polymer which is prepared by polymerizing 50 to 99.9% by weight of an alkyl acrylate, 0 to 49.9% by weight of an alkyl methacrylate, 0 to 49.9% by weight of a monofunctional monomer other than the alkyl methacrylate and alkyl acrylate, and 0.1 to 10% by weight of a polyfunctional monomer.

6. The method according to claim 5, wherein the acrylic rubber particles have a multilayer structure comprising an additional layer of a polymer formed outside the layer of said elastic polymer, wherein said polymer in the additional layer is prepared by polymerizing 50 to 100% by weight of an alkyl methacrylate, 0 to 50% by weight of an alkyl acrylate, 0 to 50% by weight of a monofunctional monomer other than the alkyl methacrylate and alkyl acrylate, and 0 to 10% by weight of a polyfunctional monomer.

7. The method according to claim 5, wherein the acrylic rubber particles have a multilayer structure comprising a further layer of a polymer formed inside the layer of said elastic polymer, wherein said polymer in the further layer is prepared by polymerizing 70 to 100% by weight of an alkyl methacrylate, 0 to 30% by weight of an alkyl acrylate, 0 to 30% by weight of a monofunctional monomer other than the alkyl methacrylate and alkyl acrylate, and 0 to 10% by weight of a polyfunctional monomer.

8. The method according to claim 6, wherein the acrylic rubber particles have a multilayer structure comprising a further layer of a polymer formed inside the layer of said elastic polymer, wherein said polymer in the further layer is prepared by polymerizing 70 to 100% by weight of an alkyl methacrylate, 0 to 30% by weight of an alkyl acrylate, 0 to 30% by weight of a monofunctional monomer other than the alkyl methacrylate and alkyl acrylate, and 0 to 10% by weight of a polyfunctional monomer.

9. The method according to claim 1, wherein the matte layer comprises a cured product of a thermosetting resin and fine particles dispersed therein.

10. The method according to claim 1, wherein the matte layer comprises a cured product of a photocurable resin and fine particles dispersed therein.

11. The method according to claim 1, wherein the matte layer comprises a thermoplastic resin and fine particles dispersed therein.

12. The method according to claim 1, wherein the transparent resin film substrate has a thickness of 20 to 200 μm, the layer (A) from 10 to 80% of the thickness of the transparent resin film substrate, and the layer (B) has a thickness of at least 10 μm.

13. The method according to claim 1, wherein the matte layer has a thickness of 1 to 20 μm.

14. The method according to claim 1, wherein the transparent resin film substrate is a laminate film comprising the layer (A) and the layers (B) formed on both surfaces of the layer (A).

15. The method according to claim 1, comprising the transparent resin film substrate and a matte layer formed on one surface of the substrate.
